(19) United States
(12) Patent Application Publication
(10) Pub. No.: US 2014/0153237 A1
(43) Pub. Date: Jun. 5, 2014

(54) LIGHT SOURCE MODULE

(71) Applicants: WINTEK CORPORATION, Taichung City (TW); Dongguan Masstop Liquid Crystal Display Co., Ltd., Dongguan City (CN)

(72) Inventors: Zhi-Ting Ye, Miaoli County (TW); Ming-Chuan Lin, Taichung City (TW)

(21) Appl. No.: 13/873,254

(22) Filed: Apr. 30, 2013

(30) Foreign Application Priority Data
Dec. 4, 2012 (TW) 101223464

(51) Int. Cl. F21V 5/00

(52) U.S. Cl. CPC F21V 5/007
USPC 362/237; 362/311.06; 362/311.02

(57) ABSTRACT

A light source module is disclosed and includes a carrier, a light-emitting unit, and a lens. The light-emitting unit is disposed on the carrier and has a light-emitting surface. The lens is disposed above the light-emitting unit and has bottom surface and a tapered top surface opposite to the bottom surface. The bottom surface is opposite right to the light-emitting surface. A gap exists between the bottom surface and the light-emitting surface. Therefore, beams emitted by the light-emitting unit are modulated by the lens to be mostly concentrated relatively in a specific radiation angle range and distributed more uniform within the specific radiation angle range, which is conducive to reduction of the glare degree of the light source module.

### BACKGROUND OF THE INVENTION

1. Field of the Invention

The invention relates to a light source module, and especially relates to a light source module using lens to modulate light field.

2. Description of the Prior Art

The light-emitting property of conventional light sources of light-emitting diode (LED) approaches a Lambertian light source. When the light source is used directly as an illumination light source, the Unified Glare Ratio (UGR) thereof may still be too high for general indoor illumination purposes (such as for reading, writing, conference, general computer work and so on), easily leading to discomfort to users. Lamps with anti-glare function on the market usually have a polarizing plate disposed in front of a light-emitting source thereof for modifying the light-emitting property thereof to reduce the UGR thereof, so as to achieve the purpose of anti-glare. However, the polarizing plate also reduces the illumination of the lamp; that is, the whole energy use efficiency of the lamp decreases. It goes against power saving tendency.

### SUMMARY OF THE INVENTION

An objective of the invention is to provide a light source module, which has a lens disposed in front of a light-emitting source thereof and uses the lens to modulate light beams for improving the light field of the light source module under insignificant influence on the whole light-emitting efficiency of the light source module, so as to reduce the UGR and reduce glare degree. Therefore, the invention can solve the problems of glare and decreased illumination due to a polarizing plate in the prior art.

The light source module of the invention includes a carrier, a light-emitting unit, and a lens. The light-emitting unit is disposed on the carrier and has a light-emitting surface. The lens is disposed above the light-emitting unit and has a bottom surface and a tapered top surface opposite to the bottom surface. The bottom surface is opposite right to the light-emitting surface. A gap exists between the bottom surface and the light-emitting surface. Thereby, light beams emitted by the light-emitting unit are modulated by the lens to be mostly concentrated relatively in a specific radiation angle range and distributed more uniform within the specific radiation angle range, which is conducive to reduction of the glare degree of the light source module. By proper design for the tapered top surface, the light source module can be applicable to general indoor illumination purposes (such as for reading, writing, conference, general computer work and so on).

Further, the tapered top surface is substantially a side surface of a cone or a pyramid. The tapered top surface has a vertex angle within a range from 140 to 160 degrees, which makes the UGR of the light source module less than 19.

In practice, the light source module can include a plurality of light-emitting units and a plurality of lenses. Each light-emitting unit corresponds to one of the lenses and is disposed to cover the corresponding lens. The light-emitting units are arranged in a row on the carrier to form a light bar, or in several rows. If the carrier is a columnar object, the light-emitting units are disposed in ring on side surfaces of the carrier. Each side surfaces thereon can dispose several of the light-emitting units. The lenses can be formed in one piece; the lenses as a whole can be regarded in logic as an optical modulation device which covers the carrier and the light-emitting units so as to forma light bar capable of emitting light at all sides. In an embodiment, the carrier includes a circuit board. The light-emitting unit is an LED device electrically connected onto the circuit board.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a light source module of a preferred embodiment according to the invention.

FIG. 2 is a sectional view of apart of the light source module in FIG. 1 along the line X-X.

FIG. 3 is a schematic diagram illustrating a light source module of another embodiment according to the invention.

FIG. 4 is a schematic diagram illustrating a light source module of another embodiment according to the invention.

FIG. 5 is a sectional view of a part of the light source module in FIG. 4 along the line Y-Y.

### DETAILED DESCRIPTION

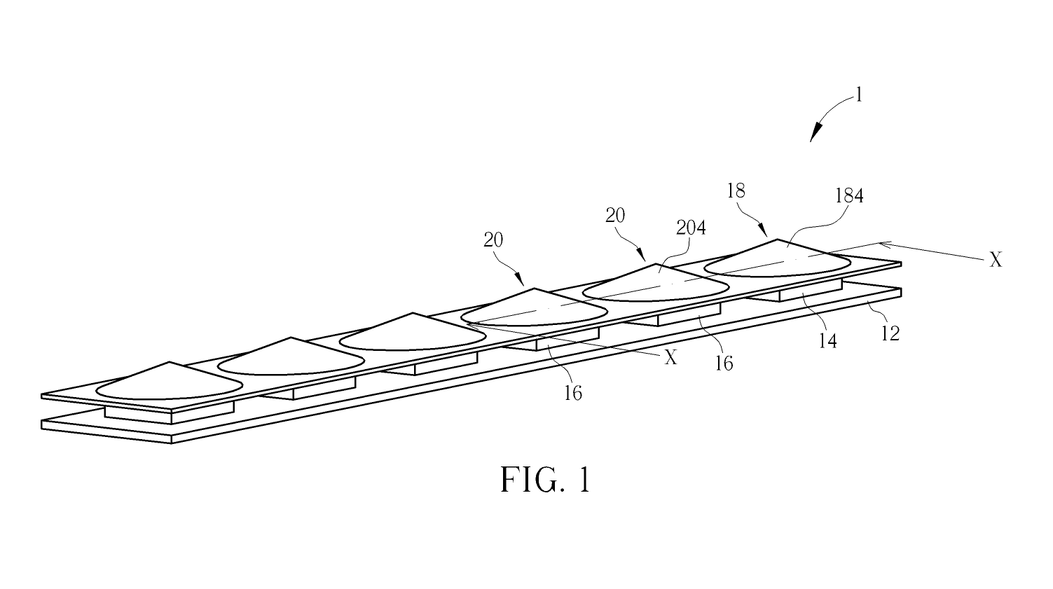

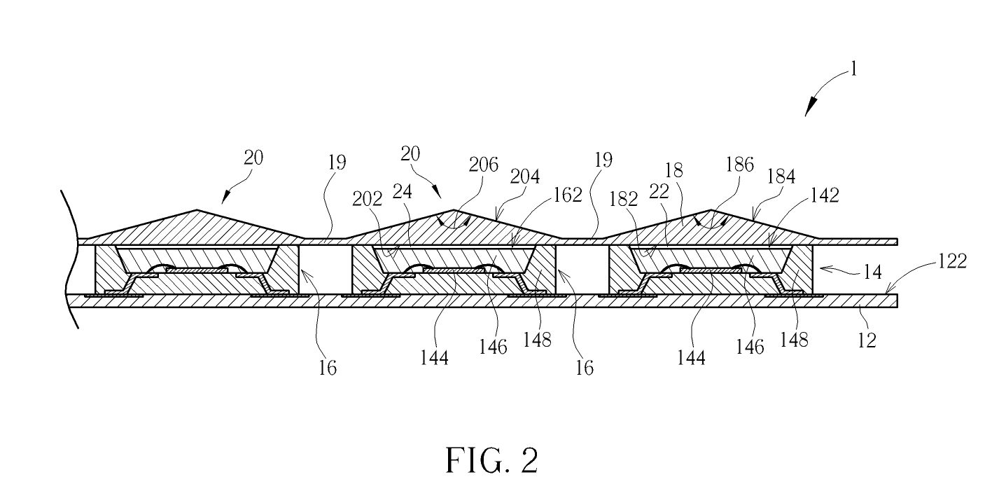

Please refer to FIG. 1 and FIG. 2. FIG. 1 is a schematic diagram illustrating a light source module 1 of a preferred embodiment according to the invention. FIG. 2 is a sectional view of a part of the light source module 1 in FIG. 1 along the line X-X. The light source module 1 includes a carrier 12, a first light-emitting unit 14, a plurality of second light-emitting units 16, a first lens 18, and a plurality of second lenses 20. The first light-emitting unit 14 is disposed on the carrier 12 and has a first light-emitting surface 142. The first lens 18 is disposed above the first light-emitting unit 14 and has a first bottom surface 182 and a first tapered top surface 184 opposite to the first bottom surface 182. The first bottom surface 182 is opposite right to the first light-emitting surface 142. A gap 22 exists between the first bottom surface 182 and the first light-emitting surface 142. Each second light-emitting unit 16 is disposed on the carrier 12 and has a second light-emitting surface 162. Each second lens 20 is correspondingly disposed above one of the second light-emitting units 16 and has a second bottom surface 202 and a second tapered top surface 204 opposite to the second bottom surface 202. The second bottom surface 202 is opposite right to the second light-emitting surface 162. A gap 24 exists between the second bottom surface 202 and the second light-emitting surface 162.

In the embodiment, the carrier 12 is a circuit board (such as a printed circuit board or a flexible circuit board) . The first light-emitting unit 14 and the second light-emitting unit 16 are an LED device respectively and electrically connected onto the circuit board, but the invention is not limited thereto. Furthermore, the first lens 18 and the second lens 20 are a cone respectively in logic and cover the first light-emitting surface 142 and the second light-emitting surface 162 respectively. The first bottom surface 182 and the second bottom surface 202 are the bottom surface of the cone. The first tapered top surface 184 and the second tapered top surface 204 are the side surface of the cone. Therein, the vertex angles 186 and 206 of the first tapered top surface 184 and the second tapered top surface 204 are within a range from 140 to 160 degrees. In practice, the first lens 18 and the second lenses 20 are formed in one piece. A connection portion 19 is used for connecting between the first lens 18 and the second lens 20 and for connecting between any adjacent second lenses 20. Therefore, the first lens 18 and the second lenses 20 as a whole can be regarded as an optical modulation device in logic, but the invention is not limited thereto. For example, the first lens 18 and the second lenses 20 are fixed on the first light-emitting unit 14 and the second light-emitting units 16 respectively. Thereby, light beams emitted by the first light-emitting unit 14 and the second light-emitting units 16 are modulated by the first lens 18 and the second lenses 20 respectively to be mostly concentrated relatively and distributed more uniform within the concentration area. Therefore, the disposition of the first lens 18 and the second lenses 20 is conducive to reduction of the glare degree of the light source module 1, which solves the problems of glare and decreased illumination due to a polarizing plate in the prior art. In the embodiment, the UGR of the light source module 1 can be less than 19, which satisfies the requirement for general indoor illumination purposes (such as for reading, writing, conference, general computer work and so on).

Furthermore, in the embodiment, after the packing gel 146 for packing the LED chip 144 of the first light-emitting unit 14 is cured, the surface of the packing gel 146 (i.e. the first light-emitting surface 142) is slightly lower than the top surface of the mount 148 of the first light-emitting unit 14, so when the first lens 18 is placed directly on the mount 148, the gap 22 is naturally formed between the first bottom surface 182 and the first light-emitting surface 142; however, the invention is not limited thereto. The above description is also applicable to the second light-emitting units 16 and the second lenses 20, which will not be described. In addition, in the embodiment, the first light-emitting unit 14 and the second light-emitting units 16 are disposed to be adjacent on the same surface 122 of the carrier 12 and be arranged in a row, so that the light source module 1 as a whole forms a light bar, but the invention is not limited thereto. For example, the first light-emitting unit 14 and the second light-emitting units 16 can be disposed on two opposite surfaces of the carrier 12.

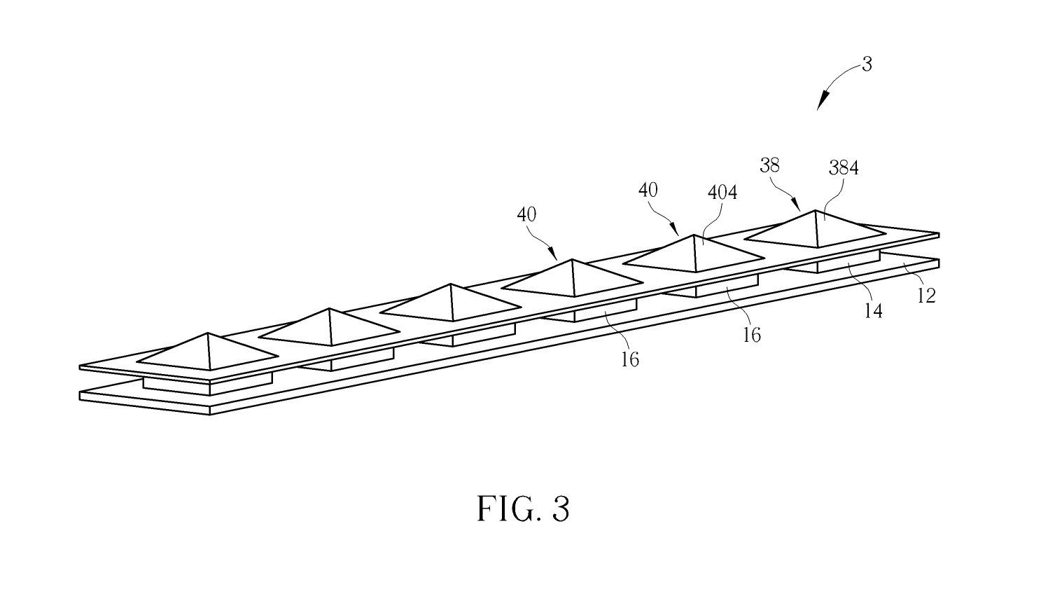

Please refer to FIG. 3, which is a schematic diagram illustrating a light source module 3 of another embodiment according to the invention. The light source module 3 is similar in structure to the light source module 1. For simple description, the light source module 3 still uses most component notations of the light source module 1. The description of the light source module 1 which is applicable herein is also applied, which will not be described in addition. The main difference between the light source module 3 and the light source module 1 is that the first lens 38 and the second lenses 40 of the light source module 3 are a pyramid respectively in logic. The first tapered top surface 384 and the second tapered top surfaces 404 are the side surface of the pyramid respectively. Therein, the vertex angles of the first tapered top surface 184 and the second tapered top surfaces 204 are within a range from 140 to 160 degrees, but the invention is not limited thereto. Furthermore, in the embodiment, the pyramid is a quadrangular pyramid, but the invention is not limited thereto. In addition, the vertex angle of the pyramid can be defined to be the double of the included angle between a perpendicular line of the vertex of the pyramid to the bottom surface of the pyramid and the side surface of the pyramid. Thereby, the vertex angles of the first tapered top surface 184 and the second tapered top surfaces 204 are within the range from 140 to 160 degrees; that is, the included angle between the side surface of the pyramid and the vertical line is within a range from 70 to 80 degrees. Similarly, light beams emitted by the first light-emitting unit 14 and the second light-emitting units 16 are modulated by the first lens 38 and the second lenses respectively to also be mostly concentrated relatively and distributed more uniform within the concentration area, which is conducive to reduction of the glare degree of the light source module 3 and solves the problems of glare and decreased illumination due to a polarizing plate in the prior art.

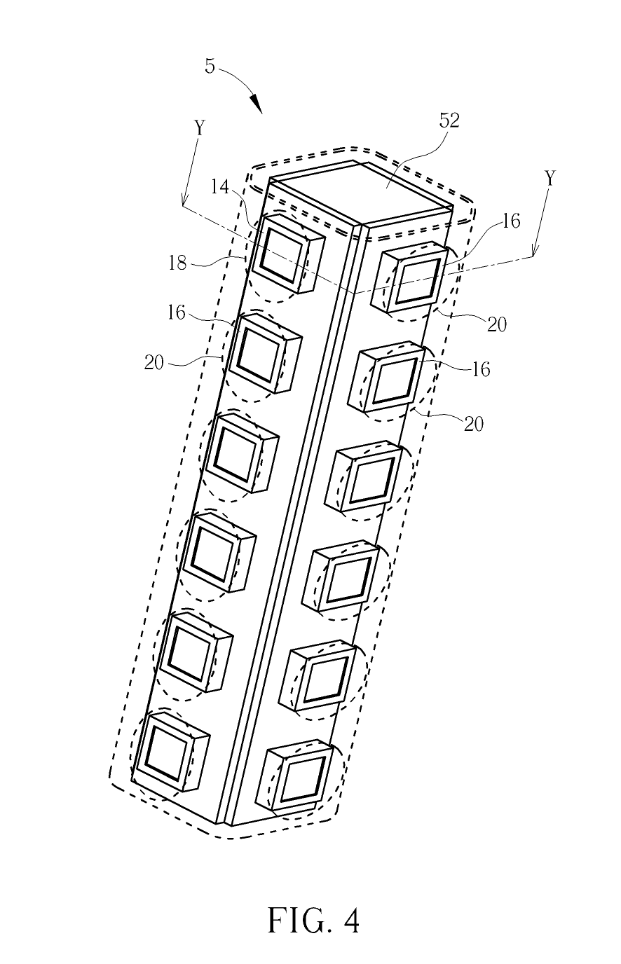

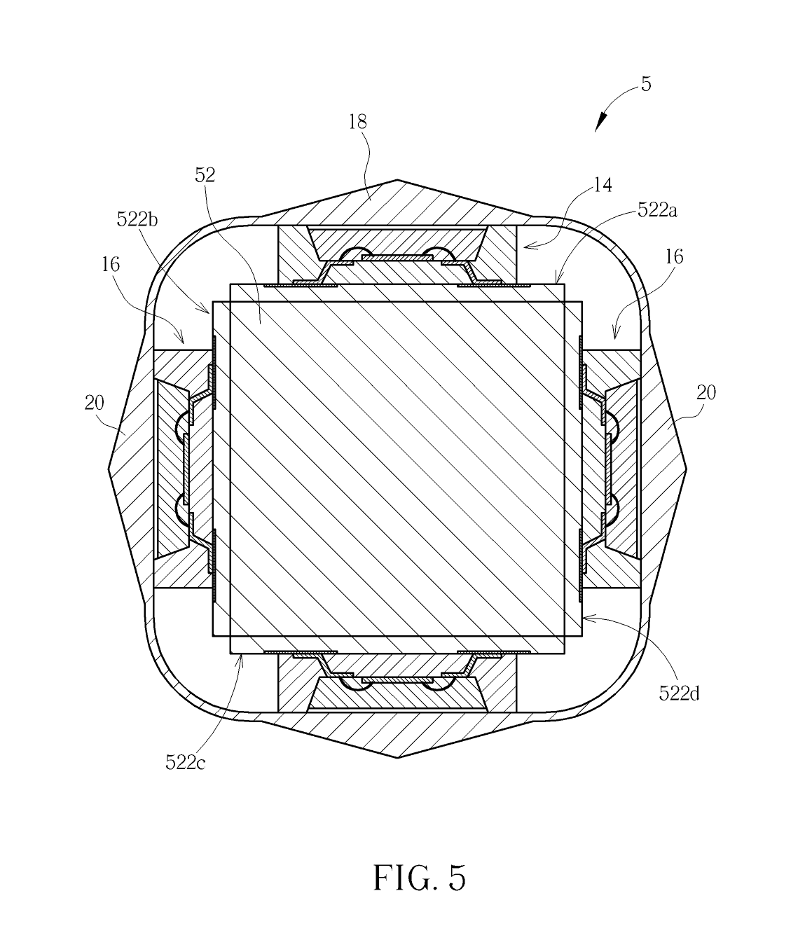

Please refer to FIG. 4 and FIG. 5. FIG. 4 is a schematic diagram illustrating a light source module 5 of another embodiment according to the invention. FIG. 5 is a sectional view of a part of the light source module 5 in FIG. 4 along the line Y-Y. The light source module 5 is similar in structure to the light source module 1. For simple description, the light source module 5 still uses most component notations of the light source module 1. The description of the light source module 1 which is applicable herein is also applied, which will not be described in addition. The main difference between the light source module 5 and the light source module 1 is that the carrier 52 of the light source module 5 is a columnar object having four side surfaces 522a, 522b, 522c and 522d connected in ring. The first light-emitting unit 14 and the second light-emitting units 16 of the light source module 5 are disposed in ring on the side surfaces 522a, 522b, 522c and 522d. The first lens 18 and the second lenses 20 of the light source module 5 are disposed above the first light-emitting unit 14 and the second light-emitting units 16 respectively. Therein, for simple description the carrier 52 carrying the light-emitting units 14 and 16 at all sides, the lenses 18 and 20 are provided to be transparent and the profiles are shown by dashed lines in FIG. 4. In the embodiment, the first lens 18 and the second lenses 20 are also formed in one piece, in practice, which can be realized by rolling up a sheet optic modulation device with the first lens 18 and the second lenses 20 thereon to be sleeved outside the carrier 52 and the light-emitting units 14 and 16.

It is added that in the embodiment, the light-emitting units 14 and 16 are disposed on all of the four sides 522a, 522b, 522c and 522d of the carrier 52, but the invention is not limited thereto. In practice, depending on the requirement of products, the light-emitting units 14 and 16 can be disposed only on two adjacent or opposite side surfaces. In addition, in practice, the carrier 52 can be realized by a metal column with a circuit board attached onto the periphery of the metal column. In such structure, the metal column can provide enough structural strength and be regarded as a medium of heat dissipation for the light-emitting units 14 and 16.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light source module, comprising:
a carrier;
a first light-emitting unit disposed on the carrier and having a first light-emitting surface; and
a first lens disposed above the first light-emitting unit and having a first bottom surface and a first tapered top surface opposite to the first bottom surface, the first bottom surface being opposite right to the first light-emitting surface, a gap existing between the first bottom surface and the first light-emitting surface.

2. The light source module of claim 1, wherein the first tapered top surface is substantially a side surface of a cone or a pyramid.

3. The light source module of claim 2, wherein the first tapered top surface has a vertex angle within a range from 140 to 160 degrees.

4. The light source module of claim 1, further comprising a second light-emitting unit and a second lens, the second light-emitting unit being disposed on the carrier and having a second light-emitting surface, the second lens being disposed above the second light-emitting unit, the second lens having a second bottom surface and a second tapered top surface opposite to the second bottom surface, the second bottom surface being opposite right to the second light-emitting surface, a gap existing between the second bottom surface and the second light-emitting surface.

5. The light source module of claim 4, wherein the first lens and the second lens are formed in one piece.

6. The light source module of claim 4, wherein the first light-emitting unit and the second light-emitting unit are disposed to be adjacent on a surface of the carrier.

7. The light source module of claim 4, wherein the carrier is a columnar object and has a first side surface and a second side surface adjacent to the first side surface, the first light-emitting unit is disposed on the first side surface, and the second light-emitting unit is disposed on the second side surface.

8. The light source module of claim 1, further comprising a plurality of second light-emitting units and a plurality of second lenses, wherein the carrier is a columnar object and has a plurality of side surfaces connected in ring, the first light-emitting unit and the second light-emitting units are disposed in ring on the side surfaces, the second lenses are disposed above the second light-emitting units respectively, each second light-emitting unit has a second light-emitting surface, each second lens has a second bottom surface and a second tapered top surface opposite to the second bottom surface, each second bottom surface is opposite right to the corresponding second light-emitting surface, and a gap exists between each second bottom surface and the corresponding second light-emitting surface.

9. The light source module of claim 8, wherein the first lens and the second lenses are formed in one piece.

10. The light source module of claim 1, wherein the carrier comprises a circuit board, and the first light-emitting unit is a light-emitting diode device electrically connected onto the circuit board.
